(19) United States
(12) Patent Application Publication
(10) Pub. No.: US 2026/0336035 A1
(43) Pub. Date: Oct. 29, 2026

(54) VEHICLE BODY LASER PAINT REMOVAL SYSTEM

(71) Applicant: Zhejiang Technical Institute of Economics, Hangzhou (CN)

(72) Inventor: YANG WANG, Hangzhou (CN)

(21) Appl. No.: 19/188,766

(22) Filed: Apr. 24, 2025

(51) Int. Cl. B23K 26/402; B23K 26/03; B23K 26/142

(52) U.S. Cl. CPC B23K 26/402; B23K 26/032; B23K 26/142

(57) ABSTRACT

A vehicle body laser paint removal system is provided, which includes a bottom plate, a dual station paint removal mechanism, a dust-and-smoke removal mechanism, and a control console. The bottom plate is laid along a factory floor, two sets of ground rail grooves are provided on the bottom plate and are extended from a middle of the bottom plate to two sides, and an isolation fence is provided at a periphery of the bottom plate. The dual station paint removal mechanism is provided at an inner side of the isolation fence and includes two sets of paint removal components arranged in opposite directions. The dust-and-smoke removal mechanism is provided on the bottom plate and located between the isolation fence and a bearing frame. The dual station design enables parallel repair work, thereby effectively improving a production capacity of vehicle body repair and metal surface treatment.

### TECHNICAL FIELD

The present disclosure relates to the field of vehicle body paint removal technologies, and in particular, to a vehicle body laser paint removal system.

### BACKGROUND

With the rapid development of automotive and manufacturing industries, traditional painting and repair techniques are facing increasing challenges. Especially in the process of repairing accident vehicles, refurbishing second-hand car parts, and surface treatment of other metal parts, traditional manual paint and rust removal methods have certain defects. Manual polishing and paint removal not only have high work intensity and low efficiency, but also easily cause secondary damage to the vehicle body surface or metal parts, affecting the quality of subsequent painting and the service life of metal parts. Besides that, traditional methods often generate large amounts of dust and waste, posing potential threats to the environment and the health of operators.

In order to improve the quality and efficiency of automobile repair and metal surface treatment, laser paint removal technology has gradually been widely applied as an emerging surface treatment process. The laser paint removal system uses high-energy laser beams to accurately remove paint layers or rust, which not only avoids surface damage that may occur in traditional manual paint removal, but also completing the paint removal task of complex shaped objects in a shorter time.

The existing technology for laser paint removal mainly focuses on the paint removal operation in the entire vehicle production line during the automobile production process, and does not involve the actual needs of accident vehicle repair, second-hand car parts refurbishment, and other metal surface treatments. In these fields, traditional manual paint removal still dominates, resulting in time-consuming and laborious paint removal processes, and it is difficult to avoid environmental pollution and safety hazards. Thus, it is particularly important to develop a laser paint removal system suitable for accident vehicle repair, second-hand parts refurbishment, and other metal surface treatments.

In addition, even if the paint removal system in the entire vehicle production line is directly applied to the automotive repair production line, there are still the following issues.

The laser paint removal devices in existing technology are usually designed for standardized vehicle production lines, and are mostly used to treat flat or simple shaped vehicle surfaces. However, during the repair process of accident vehicles, the vehicle body often undergoes deformation, with complex curves, uneven areas, and hard-to-reach parts. This may prevent existing laser paint removal systems from accurately covering these complex areas during the repair process, which results in uneven paint removal or incomplete removal of certain paint layers or rust.

The existing laser paint removal devices are usually fixed configurations or semi-automated designs, which are difficult to adapt to the changing repair needs. For example, when repairing different types of vehicles or spare parts, it may be necessary to adjust laser power, scanning speed, or laser head position. Existing systems often require manual adjustment, which not only increases operational difficulty but also reduces the flexibility and adaptability of the system in actual production. Especially when repairing accident vehicles, rapid switching and adjustment of repair processes are crucial.

### SUMMARY

The purpose of the present disclosure is to provide a vehicle body laser paint removal system, which adopts a dual station paint removal mechanism and a dust-and-smoke removal mechanism configuration. The dual station design enables parallel repair work, effectively improving production capacity of vehicle body repair and metal surface treatment, and it is particularly suitable for high-efficiency and large-scale production environments. Besides that, the dual station paint removal mechanism is provided with a robotic arm, a laser paint removal head, a vehicle body recognition device, etc., which can automatically adapt to different curved surfaces and complex structures of the vehicle body, accurately control a laser scanning path, ensure that there will be no secondary damage to the vehicle body during the repair process of the accident vehicle, and efficiently remove paint layers or rust.

To achieve the above objectives, the present disclosure provides the following technical solution: a vehicle body laser paint removal system, including a bottom plate, a dual station paint removal mechanism, a dust-and-smoke removal mechanism, and a control console,
where the bottom plate is laid along a factory floor, two sets of ground rail grooves are provided on the bottom plate; the two sets of ground rail grooves are extended from a middle of the bottom plate to two sides, and an isolation fence is provided at a periphery of the bottom plate for enclosure;
the dual station paint removal mechanism is provided on an inner side of the isolation fence; the dual station paint removal mechanism includes two sets of paint removal components that are arranged in opposite directions; each paint removal component includes a bearing frame, a first walking servo, a ground rail frame, a base, a second walking servo, a robotic arm, a laser paint removal head, and a vehicle body recognition device; the bearing frame is provided on upper sides of the ground rail grooves, and the bearing frame is moved along a length direction of the ground rail grooves through the first walking servo;
the dust-and-smoke removal mechanism is provided on the bottom plate and located between the isolation fence and the bearing frame; the dust-and-smoke removal mechanism is configured to suction and purify the smoke and dust generated during a paint removal process; the dust-and-smoke removal mechanism includes a vertical bracket, a lead screw, a sliding seat, a guide rail, an installation sliding table, an adjustment frame, a vacuum hood, an exhaust duct, and an external smoke-and-dust purifier;
the control console is provided at a periphery of the isolation fence and is connected to the dual station paint removal mechanism and dust-and-smoke removal mechanism for communication; the control console is configured to provide multi device parallel control, data acquisition, defect detection, and correction throughout an entire process of vehicle body laser paint removal.

In some embodiments of the present disclosure, the ground rail frame is mounted on the bearing frame through a rack, and the base is provided on the ground rail frame; the base is provided with a laser generator and the second walking servo that drives the base to move along the ground rail frame.

In some embodiments of the present disclosure, the robotic arm is mounted on the base through a servo turntable, and an execution end of the robotic arm is provided with the laser paint removal head and the vehicle body recognition device. The robotic arm is a multi-axis robotic arm to meet high-precision requirements for surface treatment of complex vehicle bodies or metal parts.

In some embodiments of the present disclosure, the ground rail frame is a U-shaped ground rail, ground rail frames of the two sets of paint removal components are complementary to each other; the ground rail frames of the two sets of paint removal components are driven to be in a close or separated state by the first walking servo; when the ground rail frames of the two sets of paint removal components are close together, they are combined to form a circular ground rail system. Complementary settings mean that these two sets of paint removal components can work together in spatial layout, complementing each other and forming a complementary working area. This setting can improve the efficiency of the system while avoiding bottleneck problems that may occur with a single workstation.

In some embodiments of the present disclosure, the vehicle body recognition device is a visual recognizer based on CCD, (Charge-Coupled Device) recognition, a scanner based on laser scanning recognition, a glossiness meter based on paint surface glossiness recognition, or an imaging system based on multispectral imaging recognition. The vehicle body recognition device adopts a combination of a plurality of technologies, which enables the present disclosure to provide high-precision and high-efficiency paint surface detection and repair support during the vehicle body repair process. The comprehensive application of different recognition methods ensures the ability to cope with various vehicle conditions and paint surface problems, providing accurate data support for the laser paint removal system.

In some embodiments of the present disclosure, the vertical bracket is vertically fixed to the bottom plate, and a long opening is provided in a middle of the vertical bracket; front and rear sides of the vertical bracket are respectively provided with the lead screw and the guide rail, where one end of the lead screw is driven by a reducer, and the other end of the lead screw is rotatably connected to the vertical bracket; the sliding seat is provided on the lead screw, the installation sliding table is slidably connected to the guide rail, and the sliding seat passes through the long opening through a support plate and is connected to the installation sliding table.

In some embodiments of the present disclosure, the adjustment frame is provided on a front side of the installation sliding table, and the vacuum hood is provided on an inner side of the adjustment frame; the vacuum hood is moved left and right along the adjustment frame through a third walking servo; a dust suction fan is provided on an inner side of the vacuum hood, and an upper side of the vacuum hood is connected to the external smoke-and-dust purifier through the exhaust duct.

In some embodiments of the present disclosure, a bottom side of the vacuum hood is further provided with a plurality of non-contact temperature alarms and smoke concentration alarms. The non-contact temperature alarms and smoke concentration alarms are used to warn of situations such as high temperature and high smoke concentration during laser paint removal. The vacuum hood can achieve the functions of up and down lifting and left and right movement through the drive of the reducer and the third walking servo, covering and efficiently cleaning the working range of the dual station paint removal mechanism to ensure the effective collection and purification of smoke and dust generated during the laser paint removal process.

Compared with the existing technology, the beneficial effects of the present disclosure are as follows.

The present disclosure adopts a configuration of dual station paint removal mechanism and dust-and-smoke removal mechanism. The dual station design enables parallel repair work, effectively improving the production capacity of vehicle body repair and metal surface treatment, and is particularly suitable for high-efficiency and large-scale production environments. Besides that, the dual station paint removal mechanism is provided with the robotic arm, laser paint removal head, vehicle body recognition device, etc., which can automatically adapt to different curved surfaces and complex structures of the vehicle body, and perform high-precision paint removal for uneven areas and complex surfaces of the vehicle body. Whether it is the repair of accident vehicles or the refurbishment of used car parts, it can effectively remove the paint layer in irregular areas, solving the problem that traditional paint removal methods cannot handle complex surfaces.

The laser paint removal system of the present disclosure is provided with an efficient dust-and-smoke removal device, which can effectively absorb and purify harmful smoke and dust generated during the laser paint removal process, reduce environmental pollution and the health hazards of operators.

The system of the present disclosure achieves full automation and intelligent management through the control console, which can automatically recognize the vehicle body and construct a three-dimensional paint surface model, intelligently adjust laser parameters, reduce manual intervention, and lower operational difficulty. The vehicle body recognition device is based on technologies such as CCD, laser scanning, and gloss meter, which can accurately detect the surface state of the vehicle body and provide real-time feedback data to the control system, thereby achieving precise paint removal process control.

The laser paint removal system of the present disclosure has strong flexibility and can automatically adjust process parameters according to different body components, paint layer thickness, and material types. Whether it is the paint removal of small and medium-sized parts or the overall paint removal of large vehicle bodies, the process mode can be quickly switched to meet diverse repair needs.

### BRIEF DESCRIPTION OF DRAWINGS

FIG. 1 is a schematic diagram of an overall structure of the present disclosure.

FIG. 2 is a state schematic diagram of the present disclosure during paint removal work.

FIG. 3 is a schematic structural diagram of a paint removal component in an embodiment of the present disclosure.

FIG. 4 is a schematic structural diagram of a robotic arm and a vehicle body recognition device in an embodiment of the present disclosure.

FIG. 5 is a schematic structural diagram of a dust-and-smoke removal mechanism in an embodiment of the present disclosure.

Numeral reference: 1. bottom plate; 2. ground rail groove; 3. isolation fence; 4. paint removal component; 401. bearing frame; 402. first walking servo; 403. ground rail frame; 404. base; 405. second walking servo; 406. robotic arm; 407. laser paint removal head; 408. vehicle body recognition device; 409. servo turntable; 410. laser generator; 5. dust-and-smoke removal mechanism; 501. vertical bracket; 502. lead screw; 503. sliding seat; 504. guide rail; 505. installation sliding table; 506. adjustment frame; 507. vacuum hood; 508. exhaust duct; 6. control console.

### DESCRIPTION OF EMBODIMENTS

Below, the technical solutions in the embodiments of the present disclosure will be clearly and completely described in combination with the accompanying drawings. Obviously, the described embodiments are only a part of the embodiments of the present disclosure, not all of them. Based on the embodiments of the present disclosure, all other embodiments obtained by those skilled in the art without creative work are within the protection scope of the present disclosure.

In a description of the present disclosure, it should be noted that terms “vertical”, “up”, “down”, “horizontal”, etc. indicate orientation or positional relationships based on an orientation or positional relationship shown in the accompanying drawings, only for a convenience of describing the present disclosure and simplifying the description, and do not indicate or imply that the device or element referred to must have a specific orientation, be constructed and operated in a specific orientation, and therefore cannot be understood as limiting the present disclosure.

In the description of the present disclosure, it should be noted that unless otherwise specified and limited, terms “providing”, “installation”, “connection to”, and “connection with” should be broadly understood, for example, it can be a fixed connection, a detachable connection, or integral connections; it can be a mechanical connection or an electrical connection; it can be directly connected, indirectly connected through an intermediate medium, or connected internally between two components. For those skilled in the art, specific meanings of the above terms in the present disclosure can be understood according to a specific situation.

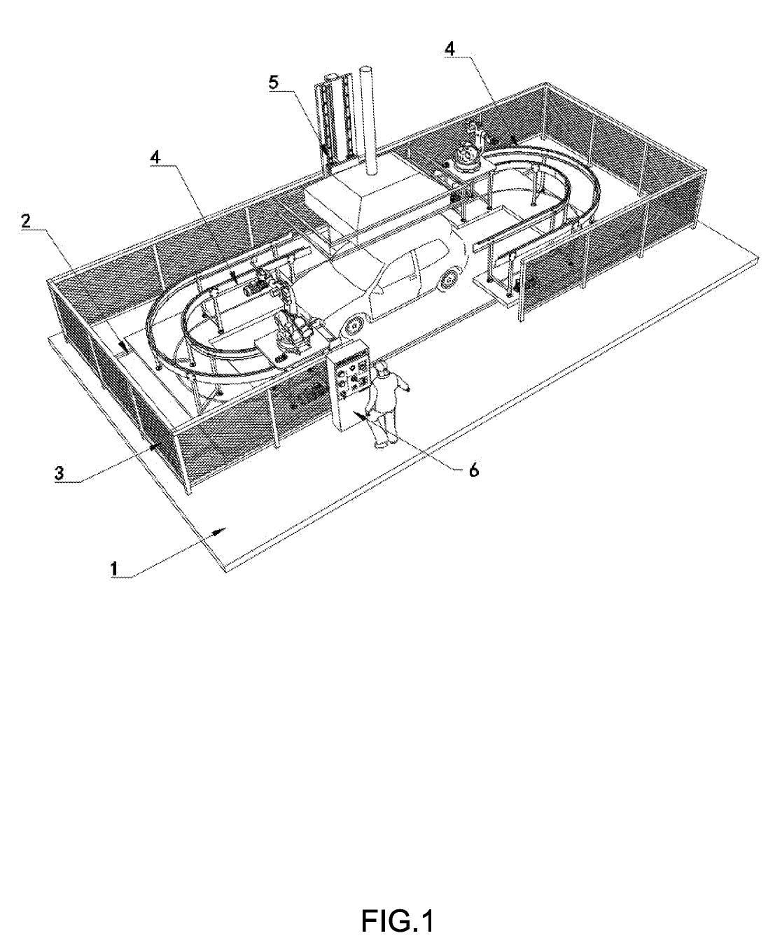

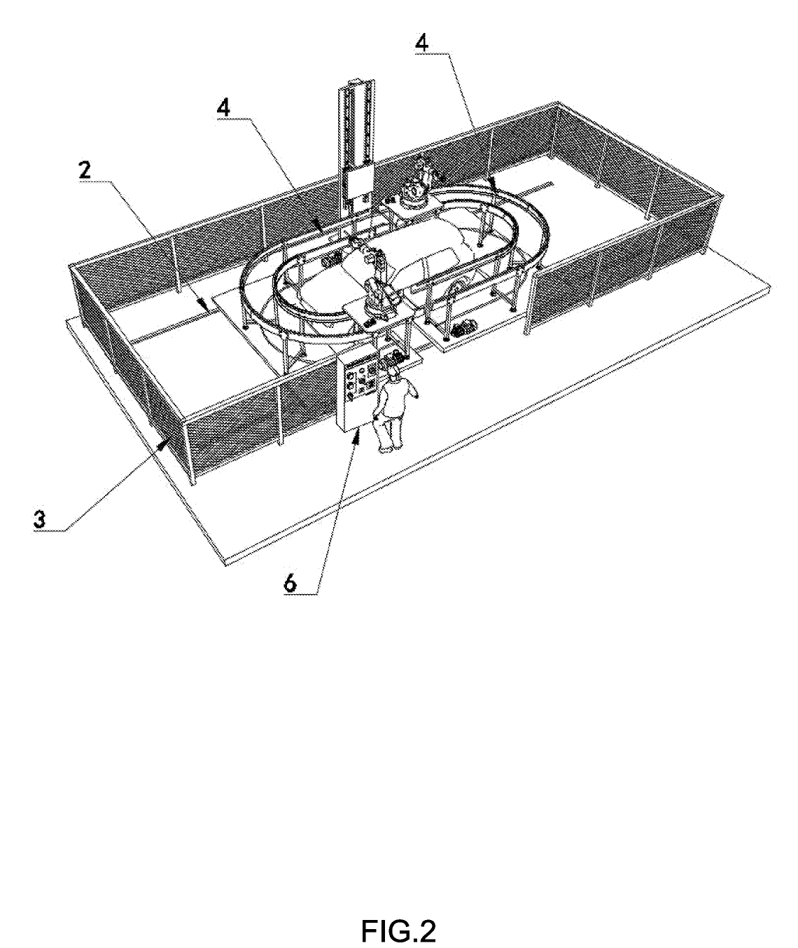

Please refer to FIGS. 1-2. The present disclosure provides a technical solution: a vehicle body laser paint removal system, including a bottom plate 1, a dual station paint removal mechanism, a dust-and-smoke removal mechanism 5, and a control console 6.

In this embodiment, the bottom plate 1 is laid along a factory floor, and two sets of ground rail grooves 2 are provided on the bottom plate 1. The two sets of ground rail grooves 2 are extended from a middle of the bottom plate 1 to two sides, and an isolation fence 3 is provided around a periphery of the bottom plate 1 for enclosure.

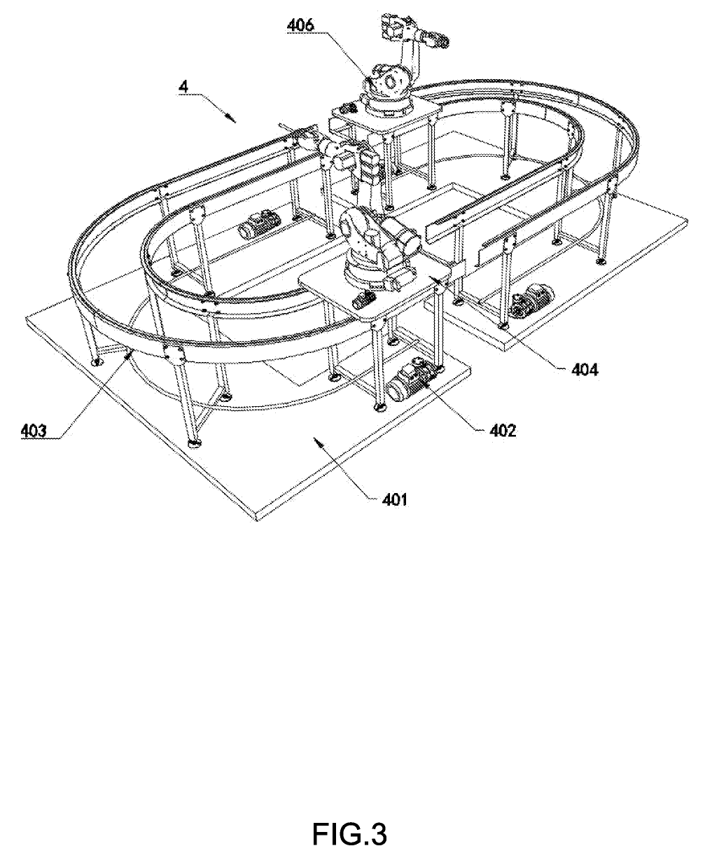

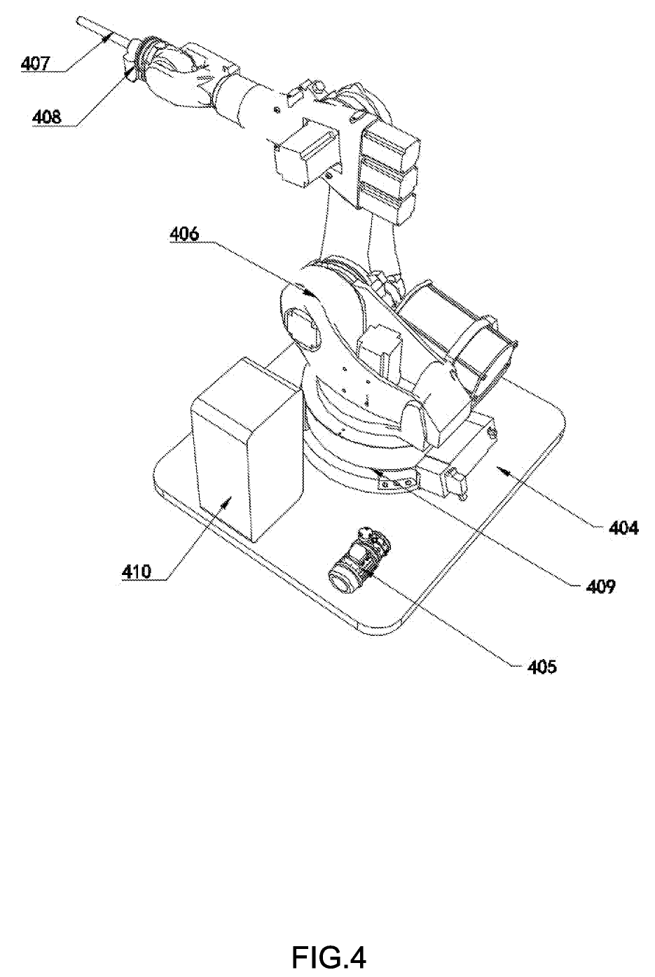

Please refer to FIGS. 1, 3, and 4. In this embodiment, the dual station paint removal mechanism is provided on an inner side of the isolation fence 3. The dual station paint removal mechanism includes two sets of paint removal components 4 arranged in opposite directions. Each paint removal component 4 includes a bearing frame 401, a first walking servo 402, a ground rail frame 403, a base 404, a second walking servo 405, a robotic arm 406, a laser paint removal head 407, and a vehicle body recognition device 408. The bearing frame 401 is provided on an upper side of the ground rail groove 2 and is moved along a length direction of the ground rail groove 2 through the first walking servo 402. The ground rail frame 403 is installed on the bearing frame 401 through a rack, and the base 404 is provided on the ground rail frame 403. The base 404 is provided with a laser generator 410 and the second walking servo 405 that drives the base 404 to move along the ground rail frame 403. The robotic arm 406 is installed on the base 404 through a servo turntable 409, and an execution end of the robotic arm 406 is provided with the laser paint removal head 407 and the vehicle body recognition device 408.

In this embodiment, the vehicle body recognition device 408 is a visual recognizer based on CCD, (Charge-Coupled Device) recognition, a scanner based on laser scanning recognition, a glossiness meter based on paint glossiness recognition, or an imaging system based on multispectral imaging recognition.

The workflow of the vehicle body recognition device 408 in this embodiment is as follows.

Vehicle scanning and data collection: the vehicle body recognition device 408 (such as CCD visual recognizer, laser scanner, gloss meter or multispectral imaging system) first scans or photographs a vehicle body surface, and obtains real-time state information of a paint layer, including paint thickness, damage, scratches, dents and other data.

Data processing and analysis: the recognition device transmits collected data to a control system, which processes and analyzes the data according to different scanning modes (such as 3D data processing or glossiness analysis).

Based on the scanning results, the control system generates a three-dimensional paint thickness model of the vehicle body and identifies areas that need to be treated (such as damaged areas, areas with thin or thick paint layers).

Automatic control of paint removal process: based on generated three-dimensional paint thickness model, the control system adjusts working parameters of the laser paint removal head 407 (such as power, frequency, scanning mode, etc.), and guides the robotic arm 406 to accurately move the laser paint removal head 407 to a predetermined area to start the paint removal operation.

The real-time feedback function of the vehicle body recognition device 408 can ensure the accuracy and effectiveness of the paint removal process, ensuring that the paint removal work only acts on a target area and does not affect other parts.

Real time adjustment and correction: during the paint removal process, the vehicle body recognition device 408 continuously monitors the paint removal progress and adjusts the position and parameters of the laser paint removal head 407 through a feedback mechanism to ensure the uniformity and quality of the paint treatment.

In this embodiment, the ground rail frame 403 is a U-shaped ground rail, and the ground rail frames 403 of the two sets of paint removal components 4 are complementary to each other. The ground rail frames 403 of the two sets of paint removal components 4 are driven by the first walking servo 402 and are in a close or separated state. When the ground rail frames 403 of the two sets of paint removal components 4 are close together, they are combined to form a circular ground rail system. Complementary settings mean that these two sets of paint removal components 4 can work together in spatial layout, complementing each other and forming a complementary working area. This setting can improve the efficiency of the system while avoiding bottleneck problems that may occur with a single workstation.

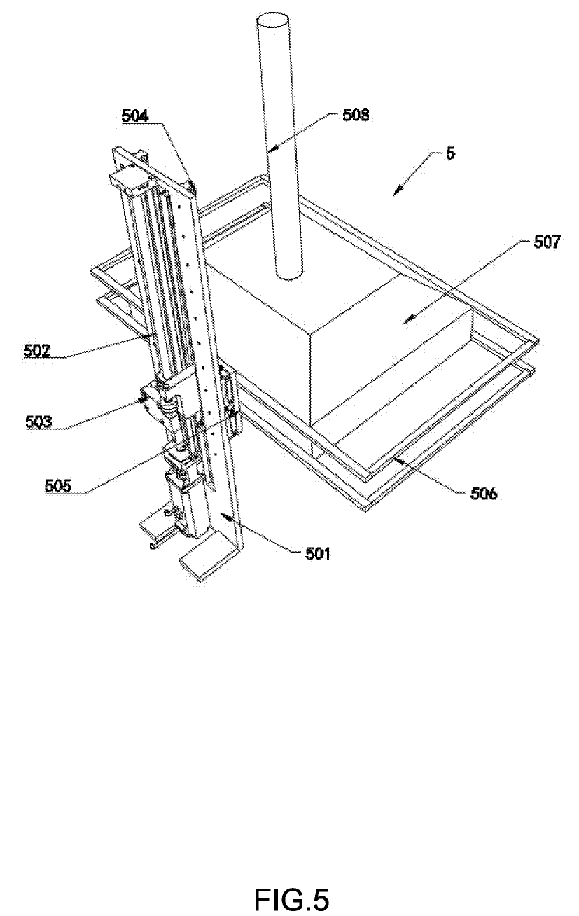

Please refer to FIGS. 1 and 5. In this embodiment, the dust-and-smoke removal mechanism 5 is provided on the bottom plate 1 and located between the isolation fence 3 and the bearing frame 401. The dust-and-smoke removal mechanism 5 is configured to suction and purify smoke and dust generated during the paint removal process. The dust-and-smoke removal mechanism 5 includes a vertical bracket 501, a lead screw 502, a sliding seat 503, a guide rail 504, an installation sliding table 505, an adjustment frame 506, a vacuum hood 507, an exhaust duct 508, and an external smoke-and-dust purifier. The vertical bracket 501 is vertically fixed on the bottom plate 1, and a long opening is provided in a middle of the vertical bracket 501. Front and rear sides of the vertical bracket 501 are respectively provided with the lead screw 502 and the guide rail 504. One end of the lead screw 502 is driven by a reducer, and the other end of the lead screw 502 is rotatably connected to the vertical bracket 501. The lead screw 502 is provided with the sliding seat 503, and the installation sliding table 505 is slidably connected to the guide rail 504. The sliding seat 503 passes through the long opening through a support plate and is connected to the installation sliding table 505. The adjustment frame 506 is provided on a front side of the installation sliding table 505, and the vacuum hood 507 is provided on an inner side of the adjustment frame 506. The vacuum hood 507 is moved left and right along the adjustment frame 506 through a third walking servo. A dust suction fan is provided on an inner side of the vacuum hood 507, and an upper side of the vacuum hood 507 is connected to the external smoke-and-dust purifier through the exhaust duct 508.

In this embodiment, a bottom side of the vacuum hood 507 is further provided with a plurality of non-contact temperature alarms and smoke concentration alarms. The non-contact temperature alarms and smoke concentration alarms are configured to warn of situations such as high temperature and high smoke concentration during laser paint removal. The vacuum hood 507 can achieve functions of up and down lifting and left and right movement through drive of the reducer and the third walking servo, thereby covering and efficiently cleaning the working range of the dual station paint removal mechanism to ensure the effective collection and purification of smoke and dust generated during the laser paint removal process.

In this embodiment, the control console 6 is provided on a periphery of the isolation fence 3 and is connected in communication with the dual station paint removal mechanism and the dust-and-smoke removal mechanism 5. The control console 6 is configured to provide multi device parallel control, data acquisition, defect detection, and correction throughout the entire process of the vehicle body laser paint removal.

Multi-device parallel control: the control console 6 coordinates and manages a plurality of devices in the system through an integrated control system and communication protocol, ensuring that each work unit can run efficiently and accurately in parallel.

Dual station paint removal mechanism: controlling the movements of laser paint removal head 407 and robotic arm 406 to accurately position and efficiently remove paint layers during the paint removal process.

Vacuum hood 507 system: adjusting lifting and movement of the vacuum hood 507 to ensure that smoke and dust can be sucked in and cleaned in a timely manner while laser paint removal.

Vehicle body recognition device 408: responsible for real-time scanning and data acquisition of the vehicle body, helping the control system identify paint defects, generating a 3D model, and accurately controlling paint removal operations.

Dust and smoke removal device: in combination with the vacuum hood 507, it works together to clean up smoke and dust, ensuring a clean workshop environment.

### Data collection and monitoring

Equipment operation data: such as power and frequency of the laser paint removal head 407, working state of the robotic arm 406, the position and working state of the vacuum hood 507, etc.

Vehicle recognition data: 3D scanning data, paint thickness, surface damage information, etc. provided by the vehicle body recognition device 408.

Smoke and temperature data: smoke concentration data provided by dust-and-smoke removal system, temperature change data from a temperature sensor, etc.

Defect detection data: information on surface defects of the vehicle body, paint layer quality, paint removal effect, etc.

Automatic correction: the system can automatically correct the deficiencies in the paint removal process based on real-time feedback, thereby improving the accuracy and quality of paint removal.

High precision defect detection: combined with the vehicle body recognition device 408 and laser paint removal system, it can accurately identify various defects on the paint surface and surface, ensuring the quality of repair.

Please refer to FIG. 2. In combination with the above embodiment, the present disclosure further proposes working steps of the laser paint removal system, including the following:

1. Vehicle transportation and positioning

Forklifts, AGV transport vehicles, or transplanting vehicles are used to transport accident vehicles or metal parts that need to be processed to the work area of the system. Then, the ground rail frame 403 of the dual station paint removal mechanism is driven by the first walking servo 402, and the ground rail frames 403 of the two sets of paint removal components 4 are separated to facilitate an entry of the vehicle body;

2) Vehicle recognition and modeling: once the vehicle enters the working area, the vehicle body recognition device 408 scans paint surface of the vehicle to be repaired in cooperation with the first servo, the second servo, and the robotic arm 406, using CCD visual recognition, laser scanning, glossiness meter and other technologies to perform detailed recognition of the vehicle body surface; the control console 6 generates a 3D paint model of the vehicle body based on the scanned information, including paint thickness, material type, and other information, thereby providing data support for subsequent laser paint removal;

3) Laser paint removal: the control console 6 automatically adjusts the working parameters of the dual station paint removal mechanism based on the three-dimensional paint surface model of the vehicle body, ensuring that the laser power, frequency, etc. of the laser paint removal head 407 are adapted to different parts of the vehicle body. The robotic arm 406 of the dual station paint removal mechanism and the laser paint removal head 407 work together to accurately move along the surface of the vehicle body. The laser beam passes through high-energy pulses to remove the paint layer by layer; during the laser paint removal process, the power, frequency, and other parameters of the laser generator 410 are automatically adjusted according to the thickness and type of the paint surface to reduce energy consumption and avoid unnecessary damage to metal parts;

4) Dust and smoke removal treatment: smoke and exhaust gas generated during the laser paint removal process are effectively treated by the dust-and-smoke removal mechanism 5. The dust removal device uses an efficient dust suction fan to ensure that the smoke and dust are timely sucked away during paint removal and treated by the external smoke-and-dust purifier, ensuring that air quality in the workshop meets environmental standards and avoiding pollution;

5) Real time monitoring and data feedback: the control console 6 monitors various data during the laser paint removal process in real time, including laser power, work progress, smoke concentration, etc. If abnormal situations occur (such as high smoke concentration or high temperature), the system will automatically alarm and adjust the paint removal process to ensure safety and process quality;

6) Completing paint removal and inspection: once the laser paint removal task is completed, the dual station paint removal mechanism stops working, and the control console 6 automatically checks the paint removal state of the vehicle body. The vehicle body recognition device 408 is configured for subsequent inspection of the paint surface to ensure that the paint removal effect meets the standards. Finally, the dual station paint removal mechanism is reset to the starting position;

7) Vehicle/metal removal and subsequent processing: when all paint removal work is completed, the vehicle body or metal parts are removed from the processing area by forklifts, AGV transport vehicles, etc. for subsequent painting or refurbishment processing. The control console 6 stores and records the paint removal data, process parameters, etc. of the entire vehicle, thereby providing data support for subsequent repair or quality control.

The above embodiments provide a fast, accurate, and environmentally friendly surface paint removal technology for vehicle bodies and metal parts through an automated and efficient laser paint removal process, combined with a synergistic effect of the dual station paint removal mechanism and the dust-and-smoke removal mechanism 5. Through the centralized management and intelligent adjustment of the control console 6, the efficiency, stability, and environmental friendliness of the entire paint removal process are ensured, which can effectively improve the quality and efficiency of accident vehicle repair, second-hand car parts refurbishment, and other metal surface treatments.

Although the embodiments of the present disclosure have been shown and described, it will be understood by those skilled in the art that various changes, modifications, substitutions, and variations can be made to these embodiments without departing from the principles and spirit of the present disclosure. The scope of the present disclosure is limited by the appended claims and their equivalents.

What is claimed is:

1. A vehicle body laser paint removal system, comprising a bottom plate, a dual station paint removal mechanism, a dust-and-smoke removal mechanism, and a control console,
wherein the bottom plate is laid along a factory floor, two sets of ground rail grooves are provided on the bottom plate; the two sets of ground rail grooves are extended from a middle of the bottom plate to two sides, and an isolation fence is provided at a periphery of the bottom plate for enclosure;
the dual station paint removal mechanism is provided on an inner side of the isolation fence; the dual station paint removal mechanism comprises two sets of paint removal components that are arranged in opposite directions;
each paint removal component comprises a bearing frame, a first walking servo, a ground rail frame, a base, a second walking servo, a robotic arm, a laser paint removal head, and a vehicle body recognition device;
the bearing frame is provided on upper sides of the ground rail grooves, and the bearing frame is moved along a length direction of the ground rail grooves through the first walking servo;
the dust-and-smoke removal mechanism is provided on the bottom plate and located between the isolation fence and the bearing frame;
the dust-and-smoke removal mechanism is configured to suction and purify the smoke and dust generated during a paint removal process;
the dust-and-smoke removal mechanism comprises a vertical bracket, a lead screw, a sliding seat, a guide rail, an installation sliding table, an adjustment frame, a vacuum hood, an exhaust duct, and an external smoke-and-dust purifier;
the control console is provided at a periphery of the isolation fence and is connected to the dual station paint removal mechanism and dust-and-smoke removal mechanism for communication;
the control console is configured to provide multi device parallel control, data acquisition, defect detection, and correction throughout an entire process of vehicle body laser paint removal.

2. The vehicle body laser paint removal system according to claim 1, wherein the ground rail frame is mounted on the bearing frame through a rack, and the base is provided on the ground rail frame;
the base is provided with a laser generator and the second walking servo that drives the base to move along the ground rail frame.

3. The vehicle body laser paint removal system according to claim 1, wherein the robotic arm is mounted on the base through a servo turntable, and an execution end of the robotic arm is provided with the laser paint removal head and the vehicle body recognition device.

4. The vehicle body laser paint removal system according to claim 1, wherein the vertical bracket is vertically fixed to the bottom plate, and a long opening is provided in a middle of the vertical bracket;
front and rear sides of the vertical bracket are respectively provided with the lead screw and the guide rail,
wherein one end of the lead screw is driven by a reducer, and the other end of the lead screw is rotatably connected to the vertical bracket.

5. The vehicle body laser paint removal system according to claim 4, wherein the sliding seat is provided on the lead screw, the installation sliding table is slidably connected to the guide rail, and the sliding seat passes through the long opening through a support plate and is connected to the installation sliding table;
the adjustment frame is provided on a front side of the installation sliding table, and the vacuum hood is provided on an inner side of the adjustment frame;
the vacuum hood is moved left and right along the adjustment frame through a third walking servo;
a dust suction fan is provided on an inner side of the vacuum hood, and an upper side of the vacuum hood is connected to the external smoke-and-dust purifier through the exhaust duct.

6. The vehicle body laser paint removal system according to claim 1, wherein the ground rail frame is a U-shaped ground rail,
ground rail frames of the two sets of paint removal components are complementary to each other;
the ground rail frames of the two sets of paint removal components are driven to be in a close or separated state by the first walking servo;
when the ground rail frames of the two sets of paint removal components are close together, they are combined to form a circular ground rail system.

7. The vehicle body laser paint removal system according to claim 1, wherein the vehicle body recognition device is a visual recognizer based on CCD, (Charge-Coupled Device) recognition, a scanner based on laser scanning recognition, a glossiness meter based on paint surface glossiness recognition, or an imaging system based on multispectral imaging recognition.

8. The vehicle body laser paint removal system according to claim 1, wherein a bottom side of the vacuum hood is further provided with a plurality of non-contact temperature alarms and smoke concentration alarms.
